(19) United States
(12) Patent Application Publication
(10) Pub. No.: US 2011/0063727 A1
(43) Pub. Date: Mar. 17, 2011

(54) Method and system with indicating marks for projection film

(76) Inventors: William Gibbens Redmann, Glendale, CA (US); Mark J. Huber, Burbank, CA (US); Joshua Pines, San Francisco, CA (US)

(21) Appl. No.: 12/807,882

(22) Filed: Sep. 16, 2010

Related U.S. Application Data
(60) Provisional application No. 61/243,099, filed on Sep. 16, 2009.

(51) Int. Cl. G02B 27/22; G03B 27/52; B32B 3/10

(52) U.S. Cl. 359/464; 355/40; 355/77; 428/195.1

(57) ABSTRACT

Indicia are established on the film to clearly indicate locations where cuts for splices may and may not be properly made. These indicia are different from each other to signify whether a cut can or cannot be made in the vicinity of the respective indicia. Differences for these indicia can be exhibited in terms of one or more of a distinctive shape or size or orientation or pattern of the indicia. When cuts and splices are correctly performed, the resulting indicia in the vicinity of the splice match substantially one of the two original indicia. When cuts and splices are incorrectly executed, the resulting indicia in the vicinity of the faulty cut and splice will be a third indicia that is combination of portions of the two original indicia. Third indicia will be different from each of the two original indicia and will therefore be readily apparent to be indicative of the presence of an incorrect cut and splice.

### CROSS-REFERENCE TO RELATED APPLICATION

The present patent application claims the benefit of priority from U.S. Provisional Patent Application Ser. No. 61/243,099, “Method and System with Indicating Marks for Three-Dimensional (3D) Projection Film,” filed on Sep. 16, 2009. The teachings of the above-identified provisional patent application are expressly incorporated herein by reference in its entirety.

### TECHNICAL FIELD

The present invention relates to projection film and, more particularly, to the use of indicating marks on the projection film for delineating gap regions between images that are either more appropriate or less appropriate for cutting and splicing.

### BACKGROUND OF THE INVENTION

The current wave of three-dimensional (3D) films is gaining popularity, which is made possible by the ease of use of digital technology and especially 3D digital cinema projection systems. However, the availability of new 3D digital cinema projection systems has been inadequate to keep pace with demand the demand for the new systems. Moreover, theater owners are finding that the changeover to the 3D digital cinema projection systems is very expensive business proposition. As a result, there is currently a move to satisfy the demand for 3D films without the use of digital technology by deploying stereoscopic film prints for presentation using a stereoscopic 3D projector.

Stereoscopic film prints are subject to all the same damages problems of any non-digital film media, especially breakage, tearing, and burning of the film itself. Experience from earlier 3D film systems cautions that, when a film is damaged and is therefore in need of repair by splicing, there is a substantial chance that the splicing and/or editing will be made incorrectly. For example, the splice can be incorrect when a segment of film cut on an inter-frame line is mated directly to a segment of film cut on an intra-frame line. From a viewing audience perspective, the effect of such an incorrect splice is severe eye strain, which can be an unpleasant and uncomfortable experience.

3D films have been produced with both thick and thin separation lines between images wherein the thick separation line is placed between left and right partial images in the same stereoscopic image pair, in which the thin separation line is placed at a position between adjacent frames parallel to the thick separation line (e.g., see ISCO OPTIC Instruction Manual for Stereovision-3D, from ISCO-OPTIC GmbH, Göttingen, Germany). These separation lines were apparently used to assist in film centering in the film gate as well as in splicing operations. However, the appearance of these parallel lines is not sufficiently different to prevent the occurrence of splicing errors. Furthermore, the subsequent detection of a splicing error and confirmation of the validity of the splice in a film using these separation lines would be difficult, if not impossible, to locate easily visually. This difficulty arises because the combination of these two separation lines in a film splice appears to be substantially identical to either one of these lines, for most any cut location.

Other problems can arise when the position for making a splice is incorrectly identified or when the splice is incorrectly made. For example, during proper operation of the system, the right-eye image and the left-eye image of a stereoscopic pair provided in a film are projected through a dual lens single-projector 3D film system so that the two images of the pair are substantially superimposed on the viewing screen. Care must be taken during film editing for the stereoscopic film to avoid any disruption in the proper sequencing and alternation of right- and left-eye images.

Needless to say, the known prior methods and apparatus appear to lack any suitable solutions for overcoming the problems related to both identifying clearly and accurately the position at which a film should be cut for splicing and confirming the validity of the splice after the splice has been made.

### SUMMARY OF THE INVENTION

Splices can be made and validated accurately at a clearly identified position in a film in accordance with the principles of the present invention by introducing first and second indicia onto the film to indicate a location where cuts and splices can and cannot be made, respectively. The first and second indicia are sufficiently different from each other that, when combined by virtue of an incorrect cut and splice, they form a third indicia that is different again from each of the first and second indicia.

Indicia are established on the film to clearly indicate locations where cuts for splices may and may not be safely and correctly made. These indicia are different from each other to signify whether a cut can or cannot be made in the vicinity of the respective indicia. Differences can be exhibited in terms of one or more of a distinctive shape or size or orientation or pattern of the indicia. When cuts and splices are correctly performed, the resulting indicia in the vicinity of the splice match substantially one of the two original indicia. When cuts and splices are incorrectly executed, the resulting indicia in the vicinity of the faulty cut and splice will be third indicia, each third indicia being a combination of portions of the two original indicia. Third indicia will be different from each of the two original indicia and will therefore be readily apparent to be indicative of the presence of an incorrect cut and splice.

One aspect of the invention provides a film, which includes a plurality of images arranged in sequential order, each of a plurality of gaps separating two adjacent images of the plurality of images, a first indicating mark for identifying a region for disallowing cutting of the film, and a second indicating mark for identifying a region proximate one of the gaps for allowing cutting of the film. The second indicating mark exhibits discernibly different properties from the first indicating mark, and any combination of cut portions of each of the first and second indicating marks results in a third indicating mark that is discernibly different from the first and second indicating marks.

Another aspect of the invention provides a film that includes a plurality of stereoscopic image pairs of first and second images arranged in sequential order, a first indicating mark for identifying a region for disallowing cutting of the film positioned substantially alongside an intra-frame gap formed between first and second adjacent images from a same stereoscopic image pair, and a second indicating mark for identifying a region for allowing cutting of the film positioned substantially alongside an inter-frame gap formed between first and second adjacent images from different stereoscopic image pairs. The second indicating mark exhibits discernibly different properties from the first indicating mark, and any combination of cut portions of each of the first and second indicating marks results in a third indicating mark which is discernibly different from the first and second indicating marks.

Yet another aspect of the invention provides a method for producing a film, which includes a plurality of pairs of first and second images arranged in sequential order, with an inter-frame gap formed between first and second adjacent images from different consecutive pairs of stereoscopic images, and an intra-frame gap formed between first and second adjacent images from a same pair of stereoscopic images. The method includes writing a first indicating mark to the film in proximity to the intra-frame gap with a film recorder, the first indicating mark for identifying a region for disallowing cutting of the film positioned substantially alongside the intra-frame gap, and writing a second indicating mark to the film in proximity to the inter-frame gap with a film recorder, the second indicating mark for identifying a region for allowing cutting of the film positioned substantially alongside the inter-frame gap. The second indicating mark exhibits discernibly different properties from the first indicating mark, and any combination of cut portions of each of the first and second indicating marks results in a third indicating mark which is discernibly different from the first and second indicating marks.

The details of one or more implementations are set forth in the accompanying drawings and the description below. Even if described in one particular manner, it should be clear that implementations may be configured or embodied in various manners. For example, an implementation may be performed as a method, or embodied as an apparatus configured to perform a set of operations, or embodied as an apparatus storing instructions for performing a set of operations. Other aspects and features will become apparent from the following detailed description considered in conjunction with the accompanying drawings and the claims.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates some elements of a film projector with a dual lens system and polarizers for showing stereoscopic film;

FIG. 2 is stereoscopic film including the indicia or indicating marks in accordance with the principles of the present invention;

FIG. 3 is a stereoscopic film including the indicia or indicating marks in accordance with the principles of the present invention wherein the film is shown to have an incorrect splice; and

FIG. 4 illustrates another embodiment of a film including indicating marks in accordance with the principles of the present invention.

The exemplary embodiments set out herein illustrate preferred embodiments of the invention, and such exemplary embodiments are not to be construed as limiting the scope of the invention in any manner.

### DETAILED DESCRIPTION

The description herein is generally presented in terms of stereoscopic film and stereoscopic image pairs for 3D presentations. But it will be understood that the principles of the present invention are also applicable to 2D films and images, as will be explained in more detail below.

In accordance with the principles of the present invention, indicia are established on the film to clearly indicate locations where cuts for splices may and may not be safely or correctly made. These indicia are different from each other to signify whether a cut can or cannot be properly made in the vicinity of the respective indicia. Differences can be exhibited in terms of one or more of a distinctive shape or size or orientation or pattern of the indicia. When cuts and splices are correctly performed, the resulting indicia in the vicinity of the splice match substantially one of the two original indicia. When cuts and splices are incorrectly executed, the resulting indicia in the vicinity of the faulty cut and splice will be a third indicia that is a combination of portions of the two original indicia. This third indicia will be different from each of the two original indicia and will therefore be readily apparent to be indicative of the presence of an incorrect cut and splice.

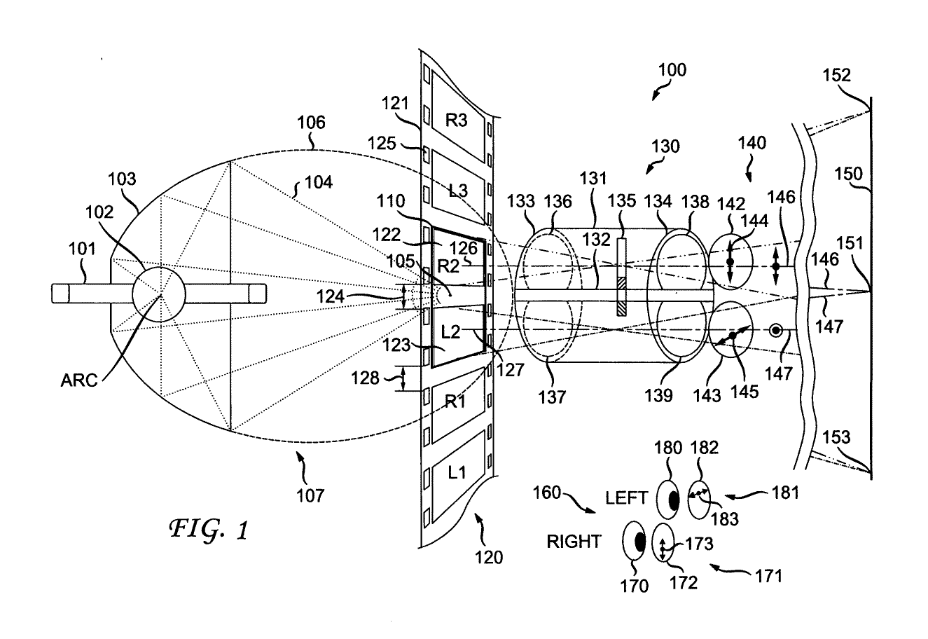

FIG. 1 shows an over-under lens 3D film projection system 100, also called a dual-lens 3D film projection system or projector. Rectangular left-eye image 122 and rectangular right-eye image 123, both on 3D film 120, are simultaneously illuminated by a light source and condenser optics, collectively called illuminator 107, which is located behind the film while framed by aperture plate 110 such that all other images on film 120 are not visible because these images are covered or otherwise obscured by the opaque portion of the aperture plate. It will be apparent to persons skilled in this art that only the inner edge of the aperture is illustrated in this figure for clarity purposes. The left- and right-eye images, which together form a stereoscopic image pair and are visible through aperture plate 110, are projected by over-under lens system 130 onto screen 150 where the images are generally aligned and superimposed on each other such that the tops of both projected images are aligned at the top edge 152 of the screen viewing area, and the bottoms of the projected images are aligned at the bottom edge 153 of the screen viewing area.

Film projector 100, which is depicted not to scale, includes an illuminator 107 in this embodiment that includes a high intensity lamp such as arc lamp 101 having envelope 102 at the center of which is a luminous arc. Reflector 103 is shown in this exemplary embodiment as substantially elliptically shaped to follow an ellipse 106 for reflecting light rays 104 from the luminous arc near the first focal point of ellipse 106 to form an image 105 of the arc near the second focal point of ellipse 106. For most film projectors, image 105 of the luminous arc is formed at or near the film gate, which is shown here as aperture 110 cut into an aperture plate. Aperture 110 is depicted in FIG. 1 as an opening for which only the boundary of the opening in the aperture plate is shown. In this way, the illumination from the luminous arc is provided as a smooth field, providing adequate illumination over the entirety of the opening for aperture 110.

Stereoscopic film 120 comprises film substrate 121 having a row of perforations 125 along each edge. The perforations allow for engagement by a sprocket or other such mechanism (none shown) to advance the film smoothly and continuously from one image to the next. As mentioned above, the images on film 120 are grouped in pairs of left and right images. Stereoscopic image pairs (R1, L1), (R2, L2), and (R3, L3) as shown in FIG. 1 are adjacent image pairs provided along film 120. For example, the stereoscopic image pair including images R2 and L2 corresponds to a right-eye image 122 and left-eye image 123, respectively. Both images from a stereoscopic image pair are simultaneously illuminated while within the opening formed by aperture 110. Images in the same stereoscopic pair such as images 122 (R2) and 123 (L2) are separated from each other by a gap defined as intra-frame gap 124. Consecutive stereoscopic image pairs, or two adjacent images (e.g., left- and right-eye images) belonging to different stereoscopic image pairs, are separated from each other by a gap defined as inter-frame gap 128. Inter-frame gap 128 may or may not exhibit the same dimensions as intra-frame gap 124. Due to the inverting nature of the projector system 100, the images on the film are provided in the projector in an inverted manner such that each image will be shown in its upright orientation when projected on the screen.

Lens system 130 comprises lens body 131 having an entrance end 133 and an exit end 134. Entrance end 133 faces film 120 and exit end 134 faces screen 150. In this embodiment, lens system 130 is a stereoscopic dual lens having an upper portion for projecting right-eye images and a lower portion for projecting left-eye images. The upper portion of lens system 130 includes entrance lens element 136 on the film side and exit lens element 138 on the screen side. The lower portion of the lens system includes entrance lens element 137 on the film side and exit lens element 139 on the screen side. Upper and lower portions of lens system 130 are separated by gap 132. Gap 132 is controllably adjustable by adjustment element 135 to have a variable gap width that can be expanded or contracted. In this embodiment, gap 132 is lined with a coating or the like to prevent leakage of light between the upper and lower portions of the lens system.

Lens system 130 also includes a filter module or assembly 140. Filter assembly 140 can include one or more of any of linear or circular polarizers or other non-polarizing filter elements, such as red/blue filters for anaglyphic 3D or multi-band interference filters, all of which are well known in the art and are suitable for separating the right- and left-eye images so that an audience member 160 can perceive a stereoscopic presentation.

In FIG. 1, a right-eye linear polarizer 142 is shown having a vertically oriented polarization axis 144, and a left-eye linear polarizer 143 is shown having a horizontally oriented polarization axis 145. Light emitted from the illuminator 107 passes through right-eye image 122 as a collection of light rays represented by centerline 126, which is imaged on screen 150 by the upper portion of lens system 130. The portion of light rays transmitted by polarizer 142, which is represented by centerline 146, and incident on screen 150 is polarized substantially parallel to polarization axis 144. In a similar manner, light emitted from the illuminator 107 passes through left-eye image 123 as a collection of light rays represented by centerline 127, which is imaged on screen 150 by the lower portion of lens system 130. The portion of light rays transmitted by polarizer 143, which is represented by centerline 147, and incident on screen 150 is polarized substantially parallel to polarization axis 145.

When properly aligned, the projections of right-eye image 122 and left-eye image 123 are substantially superimposed on screen 150. Both projected images have their respective centers substantially co-located at screen center 151, as represented in FIG. 1 by the convergence of centerlines 146 and 147. Upon projection, the tops of images 122 and 123 are both imaged substantially along top 152 of screen 150, and the bottom of images 122 and 123 are both projected substantially along bottom 153 of screen 150.

When filter module 140 employs polarizing components, such as linear polarizers 142 and 143, screen 150 should exhibit a polarization preserving property. One such polarization preserving screen is a silver screen. On the other hand, when filter module 140 does not employ polarizing component, screen 150 may be realized without the need for a polarization preserving property.

Audience member 160 is provided with 3D glasses with a right-eye portion 171 and a left-eye portion 181. Since polarization elements are used in the lens system, the 3D glasses include right-eye portion 171 comprising a linear polarizer 172 having an axis of polarization 173 in a first direction, and left-eye portion 181 comprising a linear polarizer 182 having an axis of polarization 183 in a second direction that is orthogonal to the first direction for polarization axis 173. In other embodiments where circularly polarization elements are employed in the lens system—such as where clockwise and counter-clockwise circular polarizations are used—for projecting the respective stereoscopic images, 3D glasses will be provided with corresponding circular polarizers in the two eye portions.

As shown in the exemplary embodiment of FIG. 1, when audience member 160 is seated and facing screen 150, polarization axis 173 is oriented substantially parallel to polarization axis 144 such that the projected right-eye images after reflection from screen 150 pass through right-eye polarizer 172 for viewing by audience member 160. The same reflected light for the projected right-eye images will not pass through left-eye polarizer 182, since polarization axis 144 of the right-eye images is substantially perpendicular to axis 183 in left-eye polarizer 182. Thus, only the projection of right-eye image 122 reaches the right-eye 170 of audience member 160. In a similar manner, only the projection of left-eye image 123 reaches the left-eye 180 of audience member 160 because polarization axis 145 of the left-eye images is substantially perpendicular to axis 173 in right-eye polarizer 172.

In the description herein, various terms may be used to explain the marks placed on the film in accordance with the principles of the present invention. These terms may include “marks”, “indicia”, “tick marks”, “warning bars”, “indicating marks”, “indicator marks”, and the like. The use of any or all of these terms in intended to convey the same meaning without limitation or modification, unless expressly stated to the contrary.

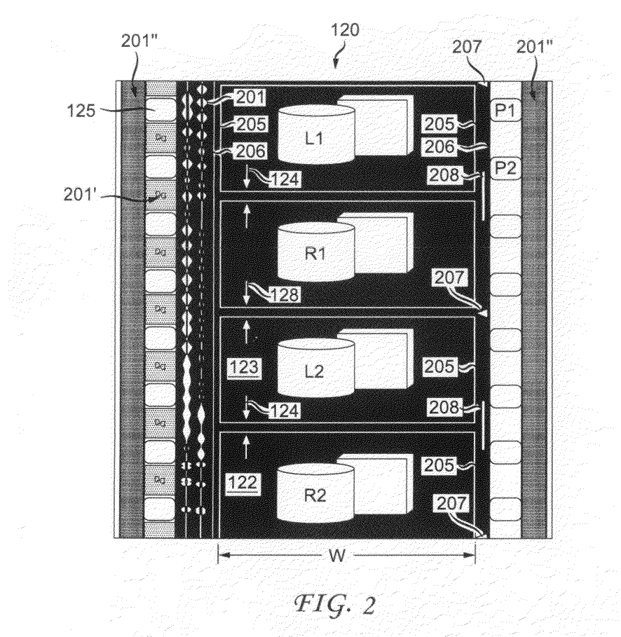

FIG. 2 shows a film print 120 including marks 207 and 208 in accordance with the principles of the present invention to identify locations where a cut for an edit may occur, and locations where a cut should not be made, respectively. The use of these marks permits easy identification of both a splice that represents a correct film edit preserving the alternating right-eye image, left-eye image sequence, and a splice that represents an incorrect film edit that results in a pseudoscopic image sequence, which disrupts and reverses the alternating right-eye image, left-eye image sequence (such that the order in which the right-eye image and the left-eye image appears in the sequence is reversed, and the images seen by the left- and right-eyes are out of synchronization by about 1/24 second).

Film print 120 has a number of stereoscopic image pairs arranged in an uninterrupted sequence of alternating right- and left-images. Right- and left-eye images 122 and 123, respectively, of the same stereoscopic pair (R2, L2) are representative images in the film reel. Right-eye image 122 and left-eye image 123 are each bounded by a respective frame boundary, shown as a maximum extent of rectangular area 205. Rectangular area 205, in turn, defines a maximum extent for a corresponding projected image. In one example, the rectangle 205 corresponds to the maximum extent of an image having a standard width (W) of 0.825″ on the film, based on a well known film format. It should be appreciated that rectangular areas 205 are not generally present or actually visible on the film. Instead, each rectangle can be considered as a virtual geometric entity to assist in the definition and understanding of image and non-image areas on the film. The size of the rectangular area is usually set by standard or convention. Regions inside the boundaries of rectangular area 205 are considered as image areas, and generally contain image content. Portions of the regions within rectangular area 205 are shown in black for ease of comprehension.

Actual dimensions for the rectangular areas 205 are typically determined in accordance with the format selected for the stereoscopic presentation. In the exemplary embodiment shown in FIG. 2, the dimensions for a standard 35 mm film run a four-perforation inter-frame height of 0.748 inches (e.g., the inter-frame height corresponds to the distance between two indicia 207 that will be discussed below). The height of a stereoscopic image can be determined as half of the inter-frame height less half the sum of the intra-frame gap 124 and inter-frame gap 128. With a 0.825″ maximum image width and an aspect ratio of 2.39:1 (scope) for each image, the image height will be about 0.345″. For a symmetric frame gap configuration, in which the inter-frame gap 128 equals the intra-frame gap 124, the gap distance will be approximately 0.029″. Clearly, these gap dimensions will be different for an asymmetric gap configuration. In other embodiments that are based on different film formats or standards, different dimensions may apply. It should be understood that the principles of the present invention apply equally to all known film formats or standards and to both asymmetric and symmetric gap configurations.

Outer edges 206 outside the rectangular areas 205 represent the expected extent of the camera aperture. That is, outer edges 206 delineate that portion of film print 120 corresponding to the portion of a film negative that would be exposed by a camera or a film recorder. Ancillary information may be introduced onto the film beyond outer edges 206. For example, as shown in FIG. 2, analog optical sound tracks 201 are shown on the film beyond edges 206. Similarly, digital optical sound tracks, such as inter-perforation sound track 201′ and extra-perforation digital sound track 201″, are also shown on the film beyond edges 206. Perforations 125 are also formed on the film in the region beyond outer edges 206. Outer edges 206 are not generally marked on the film but are virtual geometric entities which are governed in practice by standards and industry conventions.

FIG. 2 shows indicating marks 207 and 208 in different regions of the film. Indicator mark 207 is positioned in the vicinity of inter-frame gap 128, whereas indicator mark 208 is positioned in the vicinity of intra-frame gap 124. These indicating marks or indicia are further positioned outside the image regions in the areas between outer edge 206 and the frame boundary for rectangular area 205. The region in which the indicating marks are placed generally appears black or dark as shown in FIG. 2. Contrast between the indicating marks and the background color of the region in which they are positioned can greatly facilitate performance and accuracy of operations such as film cutting, splicing, and film inspection, as further discussed below. In one exemplary embodiment, indicating marks 207 and 208 appear as blank or bright marks against a dark background.

Stereoscopic film can be confusing for an individual tasked with editing the film print. In general, it is not apparent where a pair of images begins and ends or even which two consecutive or adjacent images belong to the same pair. As seen in FIG. 1 and FIG. 2, the right- and left-eye images of a stereoscopic pair are separated by intra-frame gap 124. Intra-frame gap 124 appears to be rather similar to inter-frame gap 128, which occurs between consecutive stereoscopic pairs, i.e., between two adjacent left- and right-images that belong to two different stereoscopic image pairs. Without any signs to guide an editor concerning the appearance of inter-frame gaps and intra-frame gaps, errors can easily occur during editing or repair of a stereoscopic film. For example, when a stereoscopic film 120 is cut at an intra-frame gap 124 and then spliced to another strip of stereoscopic film cut at inter-frame gap 128, the two adjacent or consecutive images (on either side of this splice) would be both right-eye images or both left-eye images.

Furthermore, the portion of the edited film following the splice will produce a sequence of images in which the order of the left- and right-eye images will be reversed or interchanged compared to the intended (or correct) order. That is, the projected right-eye image will be seen by the left eye, and the projected left-eye image will be seen by the right eye. In industry parlance, the projected presentation will switch from being stereoscopic to being pseudoscopic. Compounding this undesirable experience, of the right- and left-eye images projected simultaneously and at a frame rate of 24 frames/second, the right-eye image represents the scene at a time 1/24 second earlier than the left-eye image (since the right-eye image belongs to a stereoscopic pair X and the left-eye image belongs to the next stereoscopic pair X+1). The presence of indicating marks 207 and 208 on the film print help to avoid and minimize the occurrence of such errors during editing. Moreover, the presence of indicating marks 207 and 208 aid in the detection of such an error in the film subsequent to editing.

It is important to avoid separating a stereoscopic pair of images by cutting so that a stereoscopic image pair would be kept together during editing. By avoid this cutting error, it is less likely that images associated with the same eye would be spliced together to form adjacent images as an incorrect stereoscopic pair.

In accordance with the principles of the present invention, the film print 120 is provided with at least a first type of indicating mark, such as mark 208, to indicate or identify locations at which a cut should not be made. As shown in FIG. 2, mark 208 is positioned in the vicinity of each intra-frame gap 124. Also in accordance with the principles of the present invention, the film print 120 is provided with at least a second type of indicating mark, such as mark 207, to indicate or identify locations where edits including cuts and/or splices may be safely or properly made. Locations identified as being appropriate for making a cut and thus amenable to subsequent splicing, which is typically a part of an editing operation, include a position at which the splice will not be projected onto the screen, or a position in the vicinity of inter-frame gap 128. When cuts and splices are made at these latter positions, editing errors such as the generation of pseudoscopic images will be avoided and the existence of the correct stereoscopic pairs will be maintained.

In this exemplary embodiment shown in the figures, indicating marks 208 are provided in the form of bars or elongated strips alongside the gap and image(s) that the marks are protecting from a cut or splice. As such, these marks may be referred to as “warning bars”. Each intra-frame gap 124 on the film is provided with indicating mark 208 alongside and in close proximity to the gap, while avoiding placement of the mark in the viewable area of the associated image or images. Each mark 208 thereby defines the presence of images in the same stereoscopic image pair because the mark 208 is located in the vicinity of the intra-frame gap between the two images in the same stereoscopic image pair.

In some exemplary embodiments, it is possible that indicating marks 208 are provided at some, but not all, intra-frame gaps 124. For example, marks 208 may only be provided at or near the beginning and ending portions of each film reel, where splicing is expected to be performed by a theatre upon receipt of a film shipment. In this latter example, individual reels of a film are spliced together to build up a single continuous film stored on and played from a large film platter.

Each indicating mark 208 has a length at least equal to the gap width of intra-frame gap 124, i.e., at least co-extensive in length with the gap width. Generally, mark 208 is produced to extend beyond the gap width so that it is also adjacent to a portion of one or both images in the stereoscopic image pair. In some instance, mark 208 can be considerably longer so that it is as long as the four consecutive perforations. For this latter example, mark 208 would extend symmetrically alongside portions of each image on both sides of an intra-frame gap to cover a length of approximately two consecutive perforations (e.g., P1 and P2 in FIG. 2) in each direction from the intra-frame gap 124 and this mark would terminate so that it does not impinge on or extend to the region near inter-frame gap 128 and indicating mark 207. The use of perforations as a guide to mark placement can be better understood in the context of conventional editing practice. In editing of 2D films without marks or any such indicia, splicers (i.e., individuals skilled in the cutting, splicing, and repair of film) tend to make cuts in the film equidistant from two consecutive perforations adjacent to a gap between images in order to minimize weakening of the film by cutting close to a perforation.

It is not nearly as important to have the warning bars of marks 208 placed adjacent to images, even though locations where cuts should not be made include the image areas. Image areas are generally more easily discernable to experienced film splicers and film editors. Since film editing personnel are well-trained to avoid cutting through image areas, warning marks are deemed to be more necessary at and near the intra-frame gaps.

In the example shown in FIG. 2, indicating mark 207 is provided in the form of a triangle or an arrow pattern, in which the bright or white triangular portion identifies an inter-frame gap at which a cut and splice may be made. Indicating mark 207 may be provided for each inter-frame gap 128 in the film. But it should also be appreciated that, in the manner similar to that discussed above for mark 208, it may be desirable to provide marks 207 for only a portion of inter-frame gaps 128 such as those at or near the beginning and end sections of a reel of film, where splicing is expected to be performed.

Inter-frame gap 128 on the film is provided with indicating mark 207 alongside and in close proximity to the gap, while avoiding placement of the mark in the viewable area of the associated image or images. Each mark 207 thereby defines the proximity of images belonging to different consecutive stereoscopic image pairs because the mark 207 is located in the vicinity of the inter-frame gap 128 formed between one image from one stereoscopic image pair, e.g., image R1 from the (L1, R1) pair, and an image from another stereoscopic image pair, e.g., image L2 from the (L2, R2) pair.

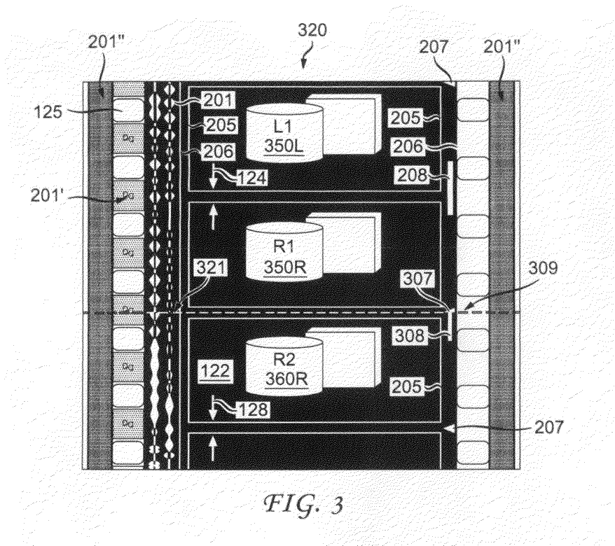

Indicating marks 207 are different in some visually discernible manner from indicating marks 208. In some examples from experimental practice, it has been found that the use of orthogonal marks has been useful. One exemplary set of orthogonal marks is shown in the figures in which mark 207 is oriented in a substantially perpendicular direction to indicating mark 208 so that one mark appears wider than it is long while the other mark appears longer than it is wide. These types of marks may also be viewed as being complementary. Regardless of the terminology used, it is important to realize that the two marks should be discernibly (or visibly) different. Moreover, when portions of these marks are joined together by an incorrect cut and splice operation, the resulting mark should be discernibly different or distinguishable from marks 207 and 208, as discussed in conjunction with FIG. 3.

Since both tick marks 207 and warning bars 208 are located outside frame boundaries defined by rectangular areas 205, these indicating marks will not be projected onto screen 150 during a normal presentation. Furthermore, by providing these marks inside the boundaries defined by edge limits 206 away from the edges of the film print 120, the indicating marks will also not interfere with any ancillary information on the film including optical soundtracks 201, 201′, and 201″.

Indicating marks 207 and 208 may also be printed in different colors to improve their detection, whether the detection is done by an automated machine or by a human. For example, tick marks 207 can be written in a green color and warning bar 208 can be written on the film in a red color. This color combination has a universal meaning that can be used herein to more clearly define regions that are respectively safe and unsafe for cutting and editing.

Indicating marks 207 and marks 208 are shown in the figures as being centered or positioned symmetrically with respect to respective inter- or intra-frame gaps. In other exemplary embodiments, one or both of marks 207 and marks 208 may be positioned in an asymmetric manner with respect to their associated frame gaps. Asymmetric positioning may result in a longer or larger portion of an indicating mark being positioned above a frame gap than the portion of the same mark positioned below the frame gap.

Once the splicing and editing of the film is complete, it may be necessary to perform an inspection of the film to check for editing errors or to perform additional quality control operations. The presence of indicating marks 207 and 208 are believed to be useful in these operations. For example, in a case where indicia or indicating marks 207 and 208 have been ignored and an improper cut and edit—such as cutting at least one warning bar 208—has been made, the resulting splice can be examined for correctness and validity. As used herein, a splice is considered “valid” when the images that are spliced together correspond to images meant for different eyes, even though these images do not necessarily belong to the same stereoscopic image pair for the same scene. If the splice does not include a warning bar 208 or some portion thereof, then the splice represents a valid splice, and indicates a valid stereoscopic sequence. Such a validity check assumes that the cuts have been done in the vicinity of a gap region, whether at an inter-frame gap or an intra-frame gap, and not across an image area where a warning bar 208 is absent. If the resulting mark at the splice includes two halves or two portions of different warning bars 208, such that the resulting film appears to have a single warning bar 208 marking the region that spans the splice, it also represents a valid splice, and indicates a valid stereoscopic sequence. Such a splice is considered valid in this particular context because the two images spliced together are associated with different eyes.

Splices can occur for a multitude of different reasons. For example, a splice may arise from an improper cut at a warning bar 208 that is subsequently spliced back together when the mistake is realized. Another type of splice may arise from an improper cut of the film, that is followed by splicing two unrelated images such as right- and left-eye images from different pairs of stereoscopic images, e.g., representing different frames or scenes. In this case, even though the two spliced images do not form the same stereoscopic pair for a particular frame, at least they will not result in pseudoscopic images when they and subsequent image pairs are projected. Generally, any adverse effect arising from viewing two unrelated images is likely to be transient in nature lasting usually for only 1/24th of a second or so.

FIG. 3 shows an example of an invalid splice, in which the composite mark 309 includes portions of each of the two original marks 207 and 208, yet is a completely different indicating mark itself. Composite mark 309 is shown in FIG. 3 as including a portion 307 of a tick mark 207 and a portion 308 of a warning bar 208. It is clear that this type of invalid splice results in two right-eye images 350R and 360R being adjacent to each other. The alternating pattern of left and right images is thereby disrupted. Thus, the splice 321 in film 320 is invalid and will corrupt the stereoscopic presentation when projected. It will be appreciated that when indicating marks 207 and 208 are positioned symmetrically with respect to their respective inter- and intra-frame gaps, and when the cuts are also made symmetrically at the gaps, then composite mark 309 will include half of indicating mark 207 and half of indicating mark 208.

Tick marks 207 and warning bars 208 not only serve as indicators for locations at which cuts or edits may be made or should not be made, but they can also be used as an inspection tool to provide a rapidly observable determination about whether an edit or splice in the stereoscopic film is valid. Although indicia 207 and 208 are shown as tick marks and warning bars, respectively, in the examples shown in the figures, it is contemplated that different designs or other patterns may be used to provide visually distinctive and discernible indicating marks in accordance with the principles of the present invention in order to facilitate inspection, film editing, splicing, and/or quality control tasks. The indicating marks may also be written as machine readable patterns, shapes, or codes.

The present invention provides a method and system suitable for use in film production, editing, and inspection, in which a film is provided both with at least a first type of indicating marks to indicate or identify location(s) where it is not suitable to perform a cut or edit, i.e., where cuts or edits are disallowed or should not be made; and a second type of indicating marks to indicate location(s) that are appropriate for making cuts or edits. The first type of marks should be sufficiently different from the second type of marks so as to allow for ready visual distinction during editing and/or inspection tasks. In some applications, it may be sufficient to provide a film with only one type of marks, e.g., the first type of indicating marks to identify a “no cut” zone, or the second type of marks to identify a “cut” zone. For example, in situations where the “cut” regions are readily identifiable by existing procedures, it is sufficient to provide only the first type of marks to indicate one or more “no cut” regions. In the scenario of having only one type of marks, an invalid splice will include only half of the indicating mark (as opposed to a composite mark containing portions of both types of indicating marks).

These marks may be written onto the film at any appropriate stage during film production or printing, e.g., using a film recorder. Furthermore, these marks may be used in quality control and inspection operations—whether done manually or in an automated manner—to indicate whether a splice is valid or proper, in which these operations are based on the types of composite or resulting mark found at a splice location. In the case of an automated method to perform splice inspection, a processor may also be configured or programmed to detect an invalid splice and to provide a warning in the event that a bad or invalid splice is found.

A system and a computer readable medium are also provided for implementing the method of the present invention. For example, the system may include one or more processors, memory devices and so on, and the computer readable medium may be programmed to contain instructions for implementing various steps related to the method of the present invention.

Although the principles of the present invention are illustrated above with examples for 3D projection, they can also be applied to 2D films such as a television or movie film or the like. The presence of a sequence of nighttime images, which would appear light in a negative, does not allow one to see a discernible gap between the images or frames. In the event that a splice should be required in such a nighttime sequence, the editor would experience significant difficulty in locating the inter-frame gap between consecutive or adjacent images, thereby making the cutting and splicing operation very difficult. In this case, a series of alternating indicating marks alongside the corresponding image regions (e.g., a first type of marks for indicating “no cut” regions) and gap region (e.g., a second type of marks for indicating “cut” regions) could prove invaluable in speeding up the editing process while affording a concomitant increase in the likelihood that the cut and splice will be performed correctly. In the case of a 2D film, the inter-frame gap is the only type of gap existing between adjacent images (i.e., intra-frame gap does not exist).

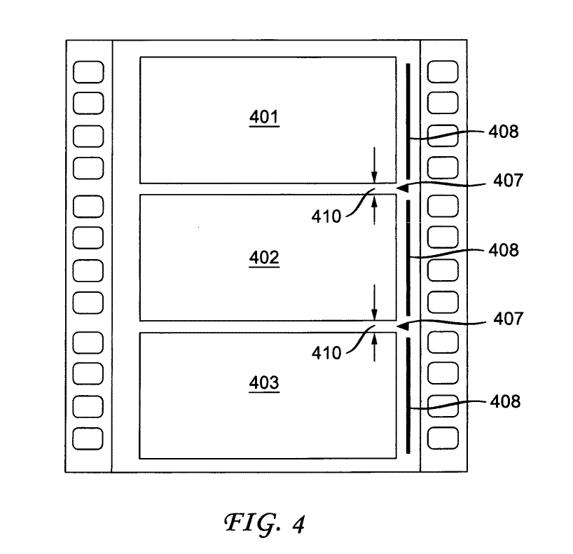

FIG. 4 illustrates an example of a portion of a 2D film negative 400, having a plurality of images 401, 402 and 403, with any two adjacent images being separated by a corresponding inter-frame gap 410. One or more indicating marks 408 (shown as dark lines in this example) can be provided along at least one side of one or more images for indicating or identifying corresponding regions that are not suitable for performing a cut. For example, some or all images on the film can have respective indicating marks 408 extending along most of the side (or length) of the corresponding images. Furthermore, one or more indicating marks 407 (shown as dark triangles in this example) can be provided proximate or alongside the respective inter-frame gaps 410 for identifying corresponding regions in the film that are suitable for performing a cut and/or splice. In this example, one indicating mark 408 is positioned alongside or adjacent to image 402, and another indicating mark 407 is positioned alongside a gap 410 that is adjacent to the image 402 (e.g., one mark 407 is alongside a gap 410 that is before image 402, and another mark 407 is alongside another gap 410 that follows image 402).

It will be understood by persons skilled in this art that the indicating marks taught herein can be written onto the film at various stages in the film production process. Obviously, a camera recorder can be adapted to write each type of indicating mark. Furthermore, during the production of a conformed negative, each indicating mark could also be written onto the film. Other stages in film production may also be more or less adaptable to the writing of these indicating marks. Writing techniques are well known in the art and are not described herein.

All examples and conditional language recited herein are intended for pedagogical purposes to aid the reader in understanding the present principles and the concepts contributed by the inventor to furthering the art, and are to be construed as being without limitation to such specifically recited examples and conditions.

Moreover, all statements herein reciting principles, aspects, and embodiments of the present invention, as well as specific examples thereof, are intended to encompass both structural and functional equivalents thereof. Additionally, it is intended that such equivalents include both currently known equivalents as well as equivalents developed in the future, including any elements developed at any that perform the same function, regardless of structure.

A number of implementations have been described herein. Nevertheless, it will be understood that various modifications may be made. For example, one or more elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. In particular, although illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. Accordingly, these and other implementations are contemplated by this application and are within the scope of the following claims.

What is claimed is:

1. A film comprising:
a plurality of images arranged in sequential order, each of a plurality of gaps separating two adjacent images of the plurality of images;
a first indicating mark for identifying a region for disallowing cutting of the film; and
a second indicating mark for identifying a region proximate one of the gaps for allowing cutting of the film;
wherein the second indicating mark exhibits discernibly different properties from the first indicating mark, and wherein any combination of cut portions of each of the first and second indicating marks results in a third indicating mark that is discernibly different from the first and second indicating marks.

2. The film of claim 1, wherein the first indicating mark is positioned alongside at least one image in the plurality of images and the second indicating mark is alongside a gap adjacent to the at least one image.

3. The film of claim 1, further comprising:
a corresponding one of the first indicating mark positioned alongside each image at each of a beginning portion and an ending portion of the film, and
a corresponding one of the second indicating mark positioned alongside each gap adjacent to each image at each of the beginning portion and the ending portion of the film.

4. The film of claim 1, wherein the first and second indicating marks are positioned outside an area including ancillary audio information on the film.

5. A film comprising:
a plurality of stereoscopic image pairs of first and second images arranged in sequential order;
a first indicating mark for identifying a region for disallowing cutting of the film positioned substantially alongside an intra-frame gap formed between first and second adjacent images from a same stereoscopic image pair; and
a second indicating mark for identifying a region for allowing cutting of the film positioned substantially alongside an inter-frame gap formed between first and second adjacent images from different stereoscopic image pairs;
wherein the second indicating mark exhibits discernibly different properties from the first indicating mark, and wherein any combination of cut portions of each of the first and second indicating marks results in a third indicating mark which is discernibly different from the first and second indicating marks.

6. The film of claim 5, further comprising:
a corresponding one of the first indicating mark positioned alongside each of a plurality of intra-frame gaps at each of a beginning portion and an ending portion of the film, and
a corresponding one of the second indicating mark positioned alongside each of a plurality of inter-frame gaps at each of the beginning portion and the ending portion of the film.

7. The film of claim 5, wherein the first and second indicating marks are positioned outside an area including ancillary audio information on the film.

8. The film of claim 5, wherein the first indicating mark is at least co-extensive in length with a width of the intra-frame gap and wherein the second indicating mark is substantially orthogonal to the first indicating mark.

9. The film of claim 8, wherein the first indicating mark is at least co-extensive in length with a portion of the first and second images adjacent to the intra-frame gap.

10. The film of claim 9, wherein the first indicating mark is positioned to extend symmetrically with respect to its associated intra-frame gap.

11. The film of claim 5, wherein the first indicating mark and the second indicating mark are substantially orthogonal to each other and exhibit shape differences.

12. The film of claim 5, wherein the first indicating mark and the second indicating mark are substantially orthogonal to each other and exhibit color differences.

13. The film of claim 5, wherein the first and second images in a pair are left and right eye images of a stereoscopic pair of images.

14. The film of claim 5, wherein the second indicating mark is at least co-extensive in length with a width of the inter-frame gap and wherein the first indicating mark is substantially orthogonal to the first indicating mark.

15. The film of claim 8, wherein the second indicating mark is at least co-extensive in length with a width of the inter-frame gap.

16. The film of claim 5, wherein the third indicating mark indicates a presence of an invalid splice.

17. The film of claim 13, wherein the third indicating mark indicates a transformation of the plurality of stereoscopic pairs of images into a sequence of pseudoscopic pairs of images.

18. A method for producing a film, the film comprising a plurality of pairs of first and second images arranged in sequential order, wherein an inter-frame gap is formed between first and second adjacent images from different consecutive pairs of stereoscopic images, and wherein an intra-frame gap is formed between first and second adjacent images from a same pair of stereoscopic images, the method comprising:
writing a first indicating mark to the film in proximity to the intra-frame gap with a film recorder, the first indicating mark for identifying a region for disallowing cutting of the film positioned substantially alongside the intra-frame gap; and
writing a second indicating mark to the film in proximity to the inter-frame gap with a film recorder, the second indicating mark for identifying a region for allowing cutting of the film positioned substantially alongside the inter-frame gap;
wherein the second indicating mark exhibits discernibly different properties from the first indicating mark, and wherein any combination of cut portions of each of the first and second indicating marks results in a third indicating mark which is discernibly different from the first and second indicating marks.
